(19) United States
(12) Patent Application Publication
(10) Pub. No.: US 2021/0064570 A1
(43) Pub. Date: Mar. 4, 2021

(54) INFORMATION PROCESSING APPARATUS, INFORMATION PROCESSING SYSTEM, AND NON-TRANSITORY COMPUTER READABLE MEDIUM STORING A PROGRAM

(71) Applicant: FUJI XEROX CO., LTD., Tokyo (JP)

(72) Inventor: Satoshi KINOSHITA, Kanagawa (JP)

(73) Assignee: FUJI XEROX CO., LTD., Tokyo (JP)

(21) Appl. No.: 16/783,329

(22) Filed: Feb. 6, 2020

(30) Foreign Application Priority Data
Aug. 28, 2019 (JP) 2019-155882

(51) Int. Cl. G06F 16/11; G06F 16/93

(52) U.S. Cl. CPC G06F 16/119; G06F 16/122; G06F 16/93

(57) ABSTRACT

An information processing apparatus includes a migration part and a change part. The migration part migrates content data of one or more files at a migration source to a migration destination in a predetermined sequence after migrating identification information to identify the one or more files at the migration source. The change part changes the predetermined sequence so as to prioritize an object in migration if the object satisfies a predetermined condition and has been subjected to an operation to use a folder, a file, or another file relating to the file. The operation is performed at the migration destination while the content data is being migrated by the migration part.

### CROSS-REFERENCE TO RELATED APPLICATIONS

This application is based on and claims priority under 35 USC 119 from Japanese Patent Application No. 2019-155882 filed Aug. 28, 2019.

### BACKGROUND

### (i) Technical Field

The present disclosure relates to an information processing apparatus, an information processing system, and a non-transitory computer readable medium storing a program.

### (ii) Related Art

Japanese Unexamined Patent Application Publication No. 2005-084963 proposes a file sharing device that includes data migrating means and access processing means. The data migrating means causes data retained in a file system of a migration source file sharing device to migrate to a file system of the file sharing device. The access processing means processes access from a host computer in correspondence to data migration statuses during the data migration processing. The access processing means provides data from the file system of the file sharing device in the case of access to data that can be used from the file system of the file sharing device and causes data to be provided from the file system of the migration source file sharing device in the case of access to data that cannot be used from the file system of the file sharing device.

Japanese Unexamined Patent Application Publication No. 2011-198071 proposes an application migration system that includes a personal computer and a migration management server. The personal computer identifies data that is necessary to execute each application installed on the personal computer, records the history of use of each application, reports the history to the migration management server, and transfers an application in accordance with a command received from the migration management server. The migration management server calculates the frequency of use of each application in accordance with the history of use of the application and sends a command to instruct the personal computer to transfer applications to another computer in order of priority based on the frequency.

### SUMMARY

A technique is known, which analyzes the frequency of use or operation priorities before data migration and sequentially migrates pieces of data in order of the frequency of use or operation priorities. However, if a migration sequence is determined and thereafter it is determined that a piece of information requires an operation, it sometimes takes a certain amount of time to make the piece of information available for the operation.

In view of the foregoing, aspects of non-limiting embodiments of the present disclosure relate to providing an information processing apparatus, an information processing system, and a non-transitory computer readable medium storing an information processing program that can shorten an amount of time required to make a piece of information available for an operation in a case where a migration sequence in which pieces of data are to be migrated is determined and thereafter it is determined that the piece of information requires the operation. The amount of time is shortened compared with a case where a migration sequence is determined before data migration and pieces of data are migrated in the migration sequence as determined.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a migration part and a change part. The migration part migrates content data of one or more files at a migration source to a migration destination in a predetermined sequence after migrating identification information to identify the one or more files at the migration source. The change part changes the predetermined sequence so as to prioritize an object in migration if the object satisfies a predetermined condition and has been subjected to an operation to use a folder, a file, or another file relating to the file. The operation is performed at the migration destination while the content data is being migrated by the migration part.

### BRIEF DESCRIPTION OF THE DRAWINGS

An exemplary embodiment of the present disclosure will be described in detail based on the following figures, wherein:

FIG. 1 is an illustration depicting a schematic configuration of an information processing system according to the present exemplary embodiment;

FIG. 2 is a block diagram depicting a configuration of major electrical components of each of an information processing terminal, a cloud server, and a server in the information processing system according to the present exemplary embodiment;

FIG. 3 is a block diagram depicting a functional configuration of the cloud server in the information processing system according to the present exemplary embodiment;

FIG. 4 is an illustration depicting an example of a migration-progress management screen and a migration-details management screen while migration is controlled;

FIG. 5 is an illustration depicting an example of a migration-control setting screen;

FIG. 6 is a flowchart depicting an example flow of migration preparatory procedures performed by a system migration service of the cloud server in the information processing system according to the present exemplary embodiment;

FIG. 7 is a flowchart depicting an example flow of a process performed by the system migration service to migrate content data of a file to a corresponding location of a file structure and identification information, which have been copied to a migration destination, in the cloud server in the information processing system according to the present exemplary embodiment;

FIG. 8 is a flowchart depicting an example flow of a process performed by the system migration service of the cloud server to identify an operation in a migration-destination document management system in the information processing system according to the present exemplary embodiment;

FIG. 9 is an illustration depicting an example list in a management table at a point before migration is started;

FIG. 10 is an illustration depicting an example list in the management table at a point after the migration is started and the migration-destination document management system is operated and before a migration sequence is changed; and

FIG. 11 is an illustration depicting an example list in the management table at a point after the migration sequence is changed.

### DETAILED DESCRIPTION

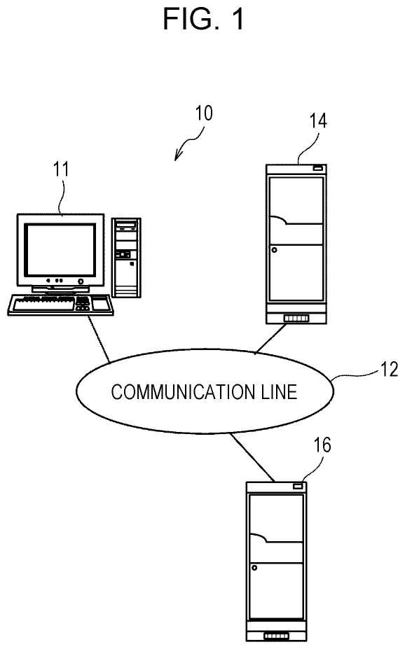

Hereinafter, an example in the present exemplary embodiment will be described in detail with reference to the drawings. In the present exemplary embodiment, an information processing system in which an information processing terminal and a plurality of servers are connected to each other via a communication line, such as various kinds of networks, will be described as an example. FIG. 1 is an illustration depicting a schematic configuration of an information processing system 10 according to the present exemplary embodiment.

The information processing system 10 according to the present exemplary embodiment includes an information processing terminal 11, a cloud server 14, which serves as an information processing apparatus, and a server 16, which serves as a migration-source manager, as depicted in FIG. 1. In the present exemplary embodiment, an example of the information processing system 10 that includes a single information processing terminal 11, a single cloud server 14, and a single server 16 is described, but the information processing system 10 may include one or more information processing terminals 11, one or more cloud servers 14, and one or more servers 16.

The information processing terminal 11, the cloud server 14, and the server 16 are connected to each other via a communication line 12, such as a local area network (LAN), a wide area network (WAN), the Internet, or an intranet. The information processing terminal 11, the cloud server 14, and the server 16 are capable of transmitting and receiving various kinds of data to and from each other via the communication line 12.

In the information processing system 10 according to the present exemplary embodiment, the cloud server 14 provides a system migration service and a document management service as a cloud service. The system migration service performs, for example, a process in which a system such as a document management system that is set up in the server 16 located on premises is migrated to a document management system provided by the cloud server 14 or to a different system such as the information processing terminal 11. In the present exemplary embodiment, system migration is described under the assumption that a system at a migration source is copied to a migration destination, but a system at a migration source may be migrated to a migration destination without retaining the system at the migration source.

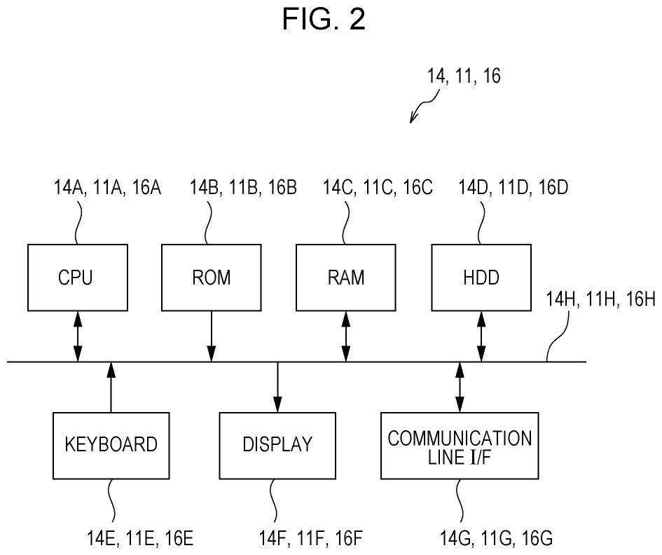

Next, a configuration of major electrical components of each of the information processing terminal 11, the cloud server 14, and the server 16 according to the present exemplary embodiment will be described. FIG. 2 is a block diagram depicting a configuration of major electrical components of each of the information processing terminal 11, the cloud server 14, and the server 16 in the information processing system 10 according to the present exemplary embodiment. The information processing terminal 11, the cloud server 14, and the server 16 each are basically designed to have a configuration of a general-purpose computer, and thus the cloud server 14 will be described as a representative example.

The cloud server 14 according to the present exemplary embodiment includes a central processing unit (CPU) 14A, a read-only memory (ROM) 14B, a random-access memory (RAM) 14C, a hard disk drive (HDD) 14D, a keyboard 14E, a display 14F, and a communication line interface (I/F) 14G, as depicted in FIG. 2. The CPU 14A manages the entire operation of the cloud server 14. The ROM 14B stores various control programs, various parameters, and the like in advance. The RAM 14C is used as a work area and the like while the CPU 14A executes various programs. The HDD 14D stores various kinds of data, application programs, and the like. The keyboard 14E is used for inputting various kinds of information. The display 14F is used for displaying various kinds of information. The communication line I/F 14G is connected to the communication line 12 and transmits and receives various kinds of data to and from other apparatuses connected to the communication line 12. All the above units in the cloud server 14 are electrically connected to each other via a system bus 14H. In the cloud server 14 according to the present exemplary embodiment, although the HDD 14D is adopted as a storage unit, this is not meant to be limiting, and a different nonvolatile storage unit, such as a flash memory, may be adopted.

In the above configuration of the cloud server 14 according to the present exemplary embodiment, the CPU 14A performs access to the ROM 14B, the RAM 14C, and the HDD 14D, acquisition of various kinds of data via the keyboard 14E, and display of various kinds of information on the display 14F. The cloud server 14 also controls by using the CPU 14A transmission and reception of communication data via the communication line I/F 14G.

In the information processing system 10 according to the present exemplary embodiment, the information processing system 10 being configured in this way, the cloud server 14 provides the system migration service and the document management service as a cloud service, as described above. In the following description, a case where the system migration service migrates a migration-source document management system 17 that is set up in the server 16 to a document management service provided by the cloud server 14 (hereinafter referred to as a migration-destination document management system 18) will be described as an example.

A technique is known for migrating a document management system. This technique analyzes the frequency of use or operation priorities before data migration and sequentially migrates pieces of data in order of the frequency of use or operation priorities. However, if a migration sequence is determined and thereafter it is determined that a piece of information requires an operation, it sometimes takes a certain amount of time to make the piece of information available for the operation. Thus, in the present exemplary embodiment, while pieces of content data are being migrated after a migration sequence in which pieces of data are to be migrated is determined, if an object requires an operation and the object, which has been subjected to the operation, satisfies a predetermined condition, control is performed to change the sequence in which pieces of content data are to be migrated so as to prioritize the object in the migration. In this way, an amount of time required to make a piece of information available for an operation is shortened in a case where a migration sequence in which pieces of data are to be migrated is determined and thereafter it is determined that the piece of information requires the operation. The amount of time is shortened compared with a case where a migration sequence is determined before data migration and pieces of data are migrated in the migration sequence as determined.

When files in a document management system are migrated, a known technique creates a complete copy and a differential copy of the entire system to migrate the system. However, while the complete copy of the entire system is being created, the system needs to be shut down. Further, the system shutdown period is sometimes prolonged in proportion to the amount of data. Thus, in the present exemplary embodiment, the file structure at a migration source and the identification information to identify a file at the migration source are copied to a migration destination before content data of one or more files at the migration source is migrated. In this way, once the file structure and the identification information are copied to the migration destination, the system at the migration destination is able to operate, and the system shutdown period is shortened compared with a case where the complete copy of the entire system is created.

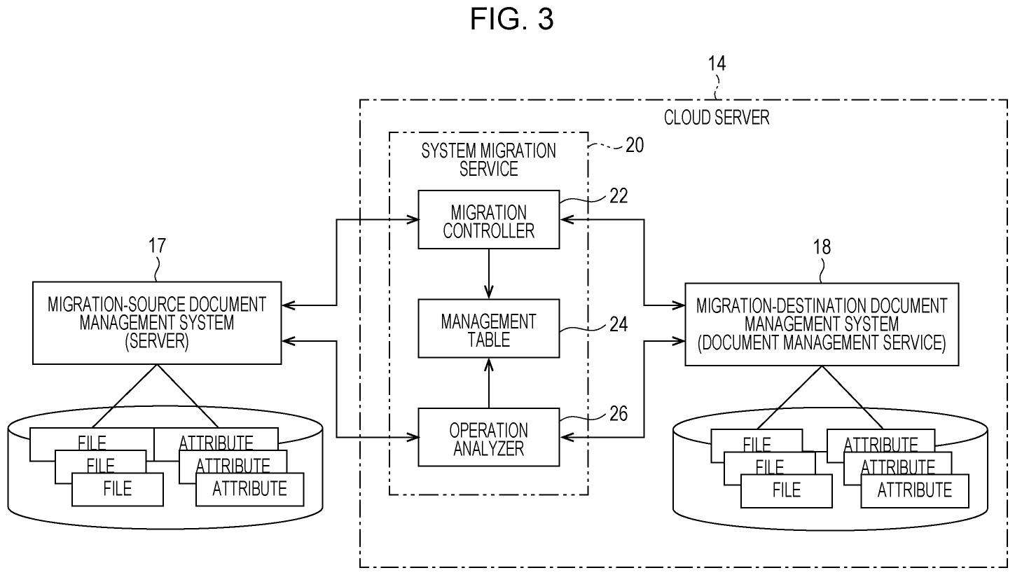

FIG. 3 is a block diagram depicting a functional configuration of the cloud server 14 in the information processing system 10 according to the present exemplary embodiment.

As described above, the information processing system 10 according to the present exemplary embodiment provides a system migration service 20 and the migration-destination document management system 18 as a cloud service.

The system migration service 20 migrates to the migration-destination document management system 18 a plurality of files and attributes of the plurality of files, both of which are managed by the migration-source document management system 17, together with the file structure including a hierarchical structure of the files.

The system migration service 20 includes functions of a management table 24, an operation analyzer 26, and a migration controller 22, as depicted in FIG. 3. The migration controller 22 corresponds to a migration part, a change part, a setting part, and a condition setting part.

The management table 24 manages the sequence and the state in which files are migrated from the migration-source document management system 17 to the migration-destination document management system 18.

The operation analyzer 26 analyzes operations in the migration-source document management system 17 and operations in the migration-destination document management system 18 to determine a migration sequence. Specifically, the operation analyzer 26 analyzes operations such as the frequencies and the numbers of access to files by using information regarding the migration-source document management system 17 and determines the sequence in which files are migrated (for example, a descending order of frequency of access or a descending order of number of access) to set the sequence in the management table 24. The operation analyzer 26 also determines operations in the migration-destination document management system 18.

The migration controller 22 controls migration of files to be migrated from the migration-source document management system 17 to the migration-destination document management system 18. In the present exemplary embodiment, a file structure at the migration source, which includes a hierarchy of files and a tree structure, and identification information to identify a file are acquired from the migration-source document management system 17, and the file structure and the identification information are copied to the migration-destination document management system 18 before content data of the files is migrated. The migration controller 22 also migrates the system by sequentially copying content data of the files in the migration-source document management system 17 to corresponding locations of the file structure and the identification information, which have been copied. Attribute information of the files may also be acquired simultaneously and copied to the migration-destination document management system 18 when the file structure and the identification information are copied to the migration-destination document management system 18. Examples of the attribute information include a registration date, an access date, a drawing number, a file type, and a document type.

In accordance with the determination made by the operation analyzer 26 regarding operations in the migration-destination document management system 18, the migration controller 22 changes the migration sequence that is set in the management table 24.

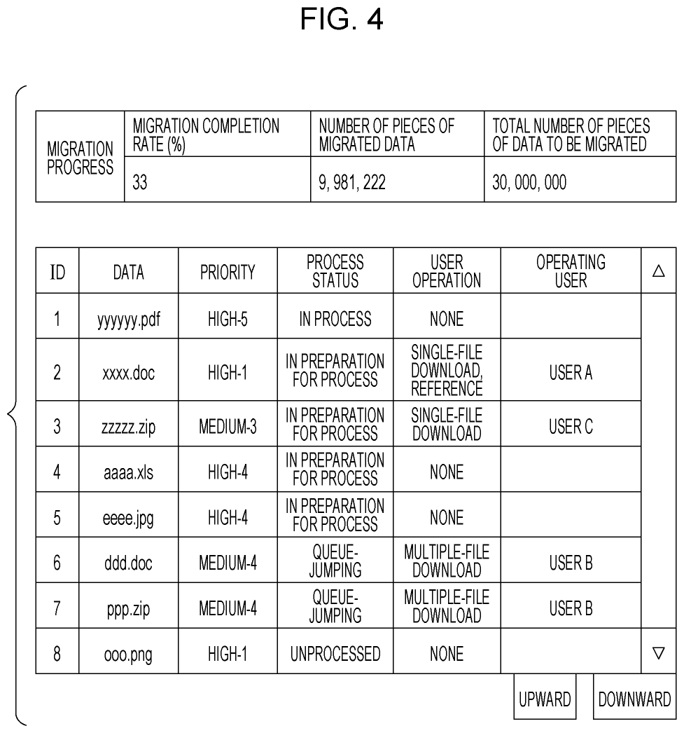

A screen displayed while migration is controlled by the migration controller 22 will be described below. FIG. 4 is an illustration depicting an example of a migration-progress management screen and a migration-details management screen while migration is controlled.

While data is migrated, the migration controller 22 has a function of managing migration progress and managing and displaying the status regarding the migration progress during migration. For example, as depicted in FIG. 4, the migration completion rate (%), the number of pieces of migrated data, and the total number of pieces of data to be migrated are displayed as an example of the status regarding the migration progress during migration.

In addition, in migration-details management, as depicted in FIG. 4, priorities of pieces of data to be migrated, process statuses of migration, user operations, operating users, and the like are listed and displayed as the migration-details management screen. The sequence of items whose process statuses of migration are not “COMPLETE” can be changed on the migration-details management screen. For example, a piece of target data in FIG. 4 is specified, and the “UPWARD” or “DOWNWARD” button is operated to change the sequence. The migration-progress management screen and the migration-details management screen are displayed on a single screen in FIG. 4 but may be displayed on separate screens.

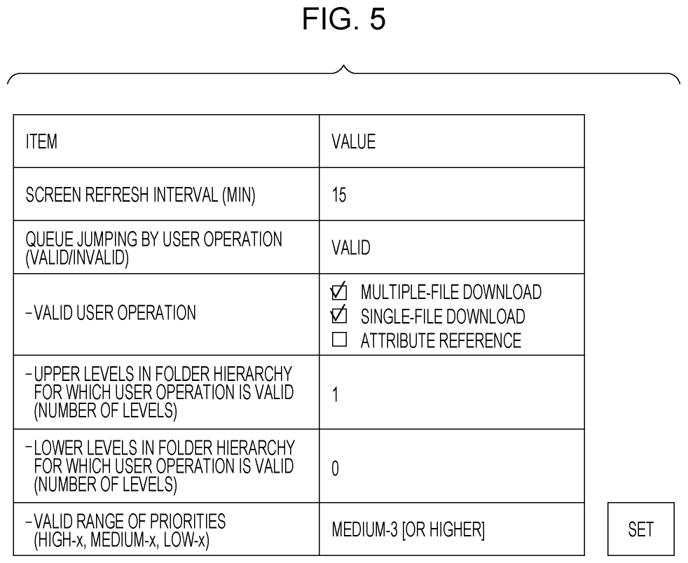

Further, the migration controller 22 uses a migration-control setting screen to configure settings for migration from the migration-source document management system 17 to the migration-destination document management system 18. For example, example settings for migration include at least one of the following items: one or more priorities that are selected from priorities assigned in advance to files and that are set as a condition in selecting an object to be migrated, a range of objects to be prioritized in migration, the number of upper levels to be migrated in the folder hierarchy, and the number of lower levels to be migrated in the folder hierarchy. In addition, the settings for migration include a user operation that is determined to be valid as an operation in the migration-destination document management system 18. FIG. 5 is an illustration depicting an example of the migration-control setting screen.

The migration-control setting screen depicted in FIG. 5 illustrates an example in which “SCREEN REFRESH INTERVAL”, “QUEUE-JUMPING BY USER OPERATION (VALID/INVALID)”, “VALID USER OPERATION”, “UPPER LEVELS IN FOLDER HIERARCHY FOR WHICH USER OPERATION IS VALID (NUMBER OF LEVELS)”, “LOWER LEVELS IN FOLDER HIERARCHY FOR WHICH USER OPERATION IS VALID (NUMBER OF LEVELS)”, and “VALID RANGE OF PRIORITIES” are set.

Next, a description will be given of a process performed by the cloud server 14 in the information processing system 10 according to the present exemplary embodiment, the information processing system 10 being configured as described above.

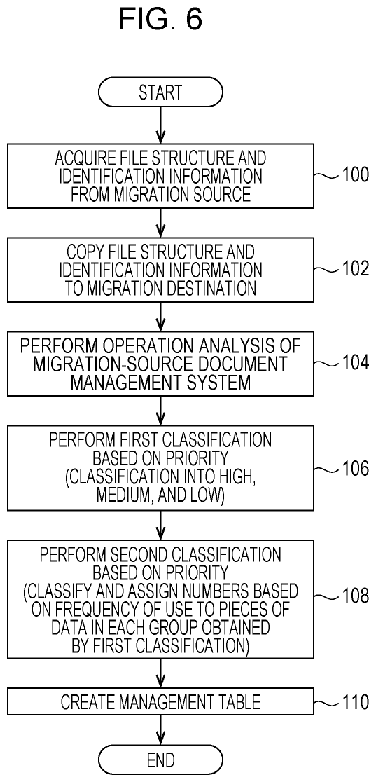

First, a process performed by the system migration service 20 as migration preparatory procedures will be described. FIG. 6 is a flowchart depicting an example flow of the migration preparatory procedures performed by the system migration service 20 of the cloud server 14 in the information processing system 10 according to the present exemplary embodiment. The process depicted in FIG. 6 starts when instructions to perform migration from the migration-source document management system 17 to the migration-destination document management system 18 are provided.

In step 100, the migration controller 22 acquires from the migration-source document management system 17 a file structure and identification information to identify a file, and the process proceeds to step 102. Step 100 corresponds to an operation performed by an acquiring part.

In step 102, the migration controller 22 copies to the migration-destination document management system 18 the file structure and the identification information, which have been acquired, and the process proceeds to step 104. Once the file structure and the identification information are copied to the migration-destination document management system 18, the file structure and the identification information are viewable, and thus the migration-destination document management system 18 is able to operate. Step 102 corresponds to an operation performed by a copying part.

In step 104, the operation analyzer 26 performs operation analysis of the migration-source document management system 17, and the process proceeds to step 106.

In step 106, the migration controller 22 performs first classification based on priority by using an analysis obtained by the operation analyzer 26, and the process proceeds to step 108. In the first classification, for example, pieces of data are classified into groups based on priority, such as high-, medium-, and low-priority groups.

In step 108, the migration controller 22 performs second classification based on priority by using the analysis obtained by the operation analyzer 26, and the process proceeds to step 110. In the second classification, for example, pieces of data subjected to the first classification and classified into groups are further classified in each group in accordance with the frequency of use or the like, and a number representing the frequency of use or the like is assigned to each piece of data in the group. Specifically, the number assigned to a piece of data increases as the number of operations or the like to which the piece of data has been subjected increases, and a higher priority is placed on a piece of data to which a larger number is assigned.

In step 110, the migration controller 22 creates the management table 24 in accordance with the first classification and the second classification, which have been performed, and a series of migration preparatory procedures is complete.

Steps 100 and 102 may be performed after the procedures from step 104 to step 110 are complete. Alternatively, steps 100 and 102 may be performed separately from step 104 to step 110.

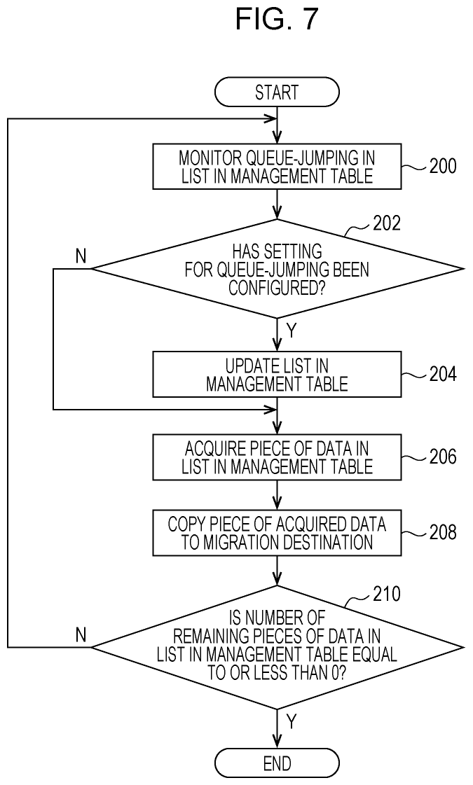

Next, a description will be given of a process performed by the system migration service 20 to copy content data of a file to a corresponding location of a file structure and identification information, which have been copied to a migration destination. FIG. 7 is a flowchart depicting an example flow of a process performed by the system migration service 20 to migrate content data of a file to a corresponding location of a file structure and identification information, which have been copied to a migration destination, in the cloud server 14 in the information processing system 10 according to the present exemplary embodiment. The process depicted in FIG. 7 starts after the file structure and the identification information have been copied to the migration destination.

In step 200, the migration controller 22 monitors queue-jumping in the list in the management table 24, and the process proceeds to step 202. Queue-jumping in the list is monitored by monitoring whether queue-jumping in the list is set by a process to identify an operation in the migration-destination document management system 18, the process being described below.

In step 202, the migration controller 22 determines whether a setting for queue-jumping has been configured. If an affirmative determination is made in step 202, the process proceeds to step 204. If a negative determination is made in step 202, the process proceeds to step 206.

In step 204, the migration controller 22 updates the list in the management table 24, leading to the queue-jumping in the migration sequence, and the process proceeds to step 206.

In step 206, the migration controller 22 acquires a piece of data in the list in the management table 24, and the process proceeds to step 208. Step 206 corresponds to an operation performed by a data acquiring part.

In step 208, the migration controller 22 copies the piece of acquired data to the migration-destination document management system 18, and the process proceeds to step 210. Step 208 corresponds to an operation performed by a data copying part.

In step 210, the migration controller 22 determines whether the number of the remaining pieces of data in the list in the management table 24 is equal to or less than 0. In other words, it is determined whether all the pieces of data to be migrated have been copied. If a negative determination is made in step 210, the process returns to step 200 and repeats the above procedure. If an affirmative determination is made in step 210, the process completes a series of procedures.

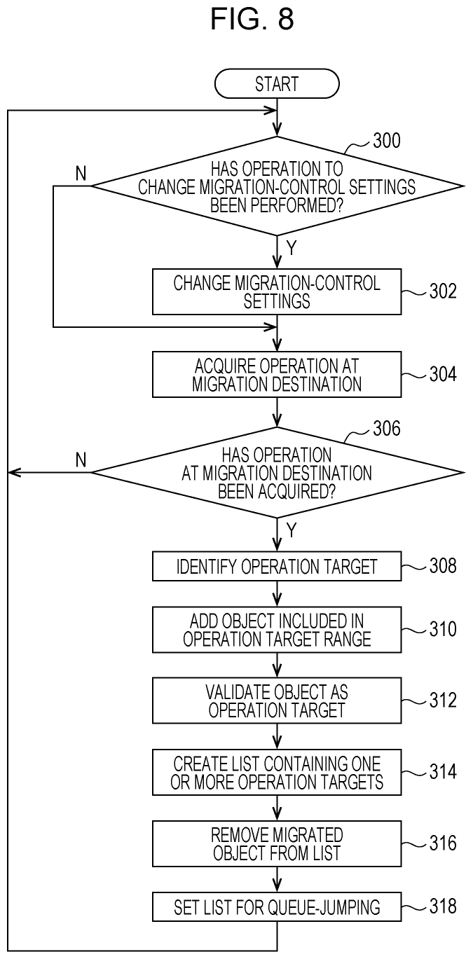

Next, a description will be given of a process that is performed by the system migration service 20 to identify an operation in the migration-destination document management system 18. FIG. 8 is a flowchart depicting an example flow of the process performed by the system migration service 20 of the cloud server 14 to identify an operation in the migration-destination document management system 18 in the information processing system 10 according to the present exemplary embodiment.

In step 300, the migration controller 22 determines whether an operation to change migration-control settings has been performed. It is determined in step 300 whether the migration-destination document management system 18 or the like has performed an operation to change the migration-control settings. If an affirmative determination is made in step 300, the process proceeds to step 302. If a negative determination is made in step 300, the process proceeds to step 304.

In step 302, the migration controller 22 changes the migration-control settings in accordance with the performed operation, and the process proceeds to step 304.

In step 304, the migration controller 22 acquires an operation in the migration-destination document management system 18, and the process proceeds to step 306.

In step 306, the migration controller 22 determines whether an operation in the migration-destination document management system 18 has been acquired. If a negative determination is made in step 306, the process returns to step 300 and repeats the above procedure. If an affirmative determination is made in step 306, the process proceeds to step 308.

In step 308, the migration controller 22 identifies an operation target, and the process proceeds to step 310.

In step 310, the migration controller 22 adds an object included in an operation target range, and the process proceeds to step 312. Specifically, an object that corresponds to “UPPER LEVELS IN FOLDER HIERARCHY FOR WHICH USER OPERATION IS VALID (NUMBER OF LEVELS)” and “LOWER LEVELS IN FOLDER HIERARCHY FOR WHICH USER OPERATION IS VALID (NUMBER OF LEVELS)”, which are set on the migration-control setting screen, is added as an object included in the operation target range.

In step 312, the migration controller 22 validates the object as an operation target, and the process proceeds to step 314. Specifically, the object is validated as an operation target in accordance with “VALID RANGE OF PRIORITIES (HIGH-x, MEDIUM-x, and LOW-x)”, which is set on the migration-control setting screen.

In step 314, the migration controller 22 creates a list containing the one or more operation targets, and the process proceeds to step 316.

In step 316, the migration controller 22 removes from the list an object that has been migrated, and the process proceeds to step 318. Specifically, if a piece of target data has been copied and migrated to the migration destination, such a piece of target data, which has been migrated, is removed from the list.

In step 318, the migration controller 22 sets the list for queue-jumping, and the process returns to step 300 and repeats the above procedure. Specifically, in the migration-destination document management system 18, when an operation to use a folder, a file, or another file relating to the file is performed at the migration destination during migration of the content data and an object subjected to the operation satisfies a condition defined by the migration-control settings, the list is set for queue-jumping to prioritize the object in migration. In this way, the management table 24 is updated and the migration sequence is changed in step 204, which is described above. Steps 306 to 318 correspond to operations performed by the change part.

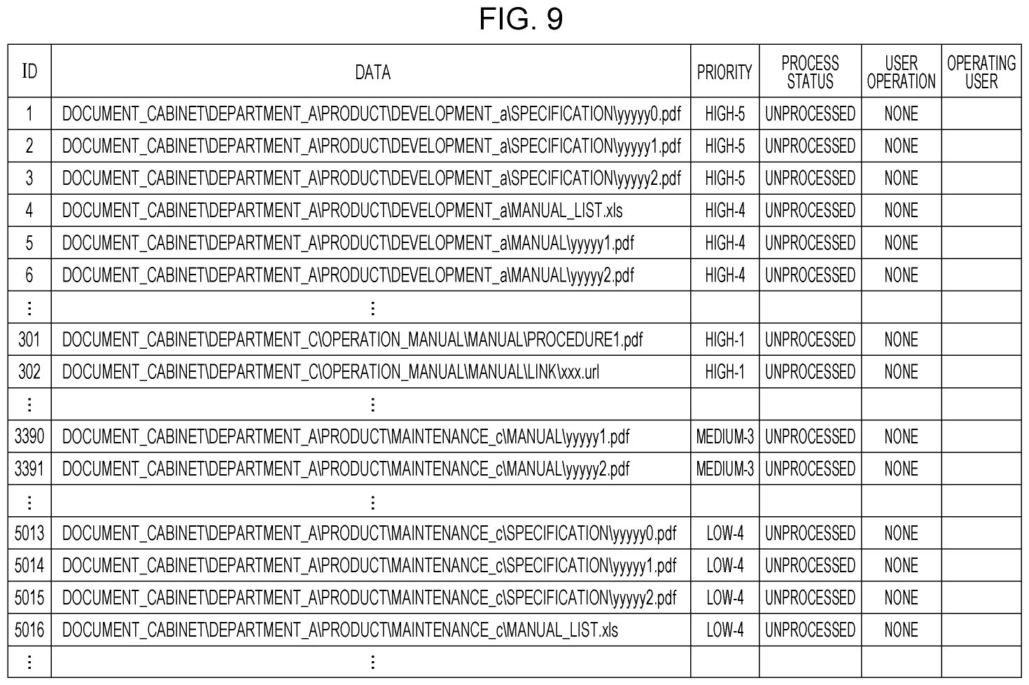

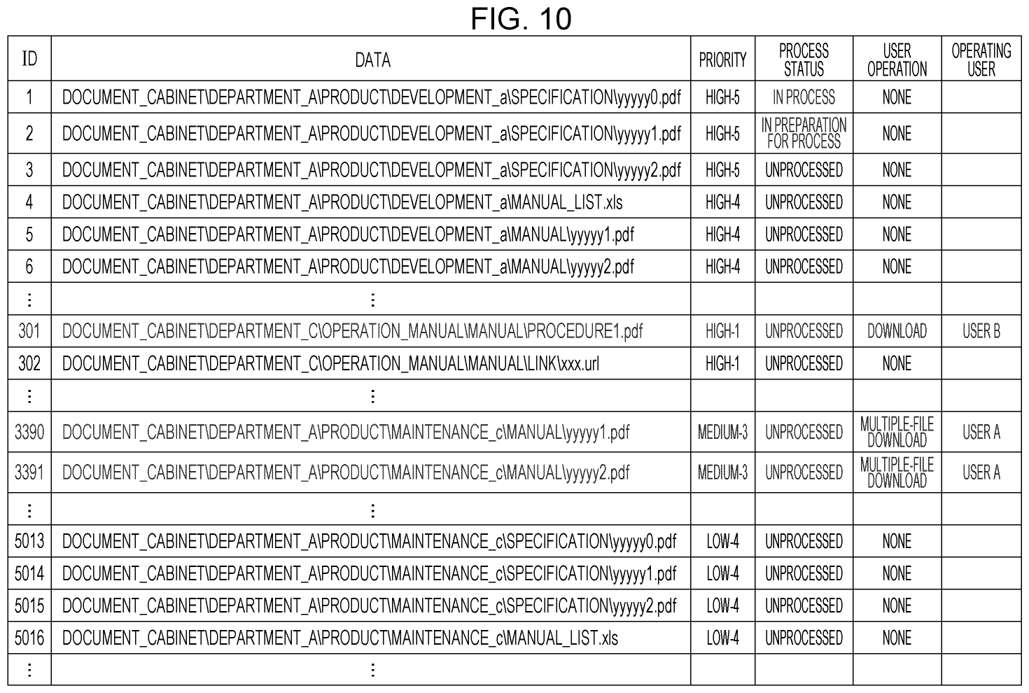

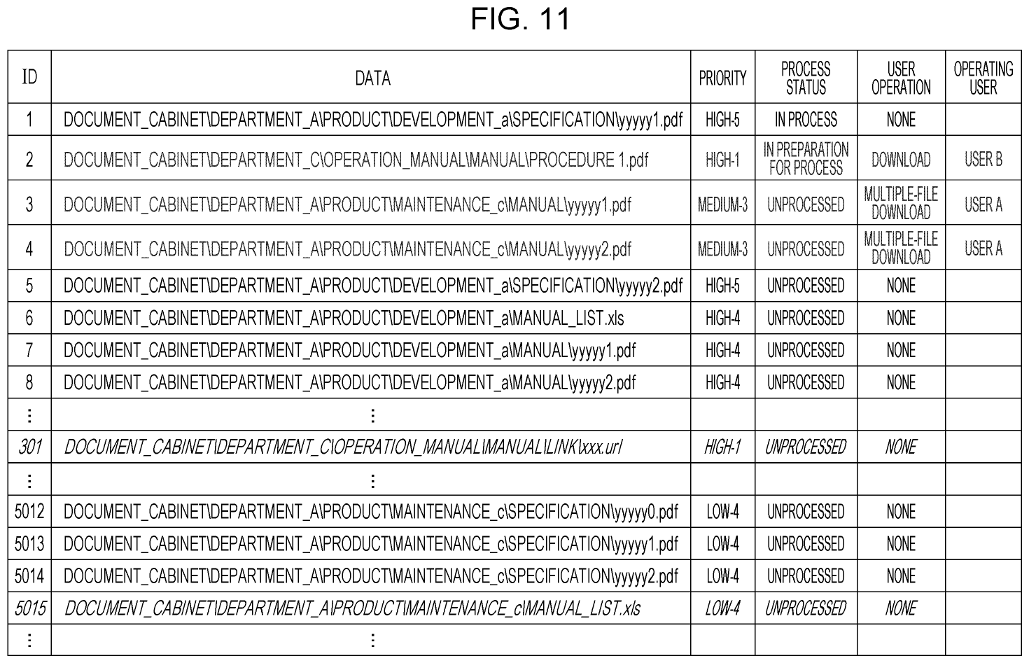

Next, a specific example of a change of a migration sequence of pieces of content data will be described. FIG. 9 is an illustration depicting an example list in the management table 24 at a point before migration is started. FIG. 10 is an illustration depicting an example list in the management table 24 at a point after the migration is started and the migration-destination document management system 18 is operated and before a migration sequence is changed. FIG. 11 is an illustration depicting an example list in the management table 24 at a point after the migration sequence is changed.

In contrast to the list in the management table 24 at a point before migration is started, which is depicted in FIG. 9, once the migration of content data is started, the process status of ID 1 changes to “IN PROCESS”, and the process status of ID 2 changes to “IN PREPARATION FOR PROCESS” as depicted in FIG. 10. It is assumed that a user A performs an operation of downloading data of multiple files, which are ID 3390 “DOCUMENT_CABINET\DEPARTMENT_A\PRODUCT\MAINTENANCE_c\MANUAL yyyyy1.pdf” and ID 3391 “DOCUMENT_CABINET\DEPARTMENT_A\PRODUCT\MAINTENANCE_c\MANUAL yyyyy2.pdf” and a user B performs an operation of downloading data of a single file, which is ID 301 “DOCUMENT_CABINET\DEPARTMENT_C\OPERATION_MANUAL\MANUAL\PROCEDURE1.pdf” as depicted in FIG. 10. It is also assumed that the migration-control settings in this example is configured as depicted in FIG. 5.

Performing the above operations makes the determination in step 306, which is described above, affirmative. Then, one or more objects included in an operation target range are added, and the one or more objects are validated as operation targets. Subsequently, a list containing the operation targets is created and set for queue-jumping. Consequently, the list in the management table 24 is updated in step 204.

Once the list in the management table 24 is updated, a migrated object (ID 1 in FIGS. 9 and 10) is removed from the list as depicted in FIG. 11. Since ID 2 in FIG. 10 is in preparation for process, this object is not affected by the queue-jumping based on priorities and moved upward to become ID 1 and in process as depicted in FIG. 11.

Since ID 301, ID 3390, and ID 3391 in FIG. 10 are identified as operation targets, these objects are moved upward, and IDs of these pieces of data, which have been subjected to operations, are changed to ID 2 to ID 4 as depicted in FIG. 11. If a plurality of objects are processed simultaneously, an object to which a higher priority has been assigned is prioritized.

Since “LOWER LEVELS IN FOLDER HIERARCHY FOR WHICH USER OPERATION IS VALID (NUMBER OF LEVELS)” in the migration-control settings is set to 0, ID 302 in FIG. 10 is not subjected to movement in the migration sequence and becomes ID 301, which is denoted in italics in FIG. 11.

Further, although ID 5016 in FIG. 10 satisfies the condition defined by “UPPER LEVELS IN FOLDER HIERARCHY FOR WHICH USER OPERATION IS VALID (NUMBER OF LEVELS)” in the migration-control settings, this object does not satisfy the condition defined by “VALID RANGE OF PRIORITIES (HIGH-x, MEDIUM-x, and LOW-x)”. Thus, this object is not subjected to movement in the migration sequence and becomes ID 5015, which is denoted in italics in FIG. 11.

In the above exemplary embodiment, the content data of files are sequentially copied after the file structure and the identification information are copied to the migration destination, but this is not meant to be limiting. For example, a system may be adopted in which only the identification information, such as file names, is copied to the migration destination without the file structure being copied to the migration destination before the content data of files is migrated and thereafter the file structure and the content data of files are sequentially copied.

The system migration from the server 16 to the cloud server 14 is described as an example in the above exemplary embodiment, but this is not meant to be limiting. For example, the above exemplary embodiment may be applied to a system migration between two of the servers 16 on premises or to a system migration between two of the cloud servers 14.

The process performed by the cloud server 14 according to the above exemplary embodiment may be a process performed by using software, a process performed by using hardware, or a process performed by using a combination of software and hardware. The process performed by the cloud server 14 may be stored in a recording medium as a program and distributed by using the recording medium.

The present disclosure is not limited to the above embodiment, and various modifications other than the above embodiment may obviously be practiced as long as they do not depart from the spirit of the disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a migration part that migrates content data of one or more files at a migration source to a migration destination in a predetermined sequence after migrating identification information to identify the one or more files at the migration source; and
a change part that changes the predetermined sequence so as to prioritize an object in migration if the object satisfies a predetermined condition and has been subjected to an operation to use a folder, a file, or another file relating to the file, the operation being performed at the migration destination while the content data is being migrated by the migration part.

2. The information processing apparatus according to claim 1, further comprising:
a setting part that sets the predetermined condition.

3. The information processing apparatus according to claim 2,
wherein the setting part selects one or more priorities from priorities assigned in advance to the one or more files and sets the one or more priorities as the predetermined condition in selecting an object to be migrated.

4. The information processing apparatus according to claim 2,
wherein the setting part further sets a range of objects to be prioritized in migration.

5. The information processing apparatus according to claim 3,
wherein the setting part further sets a range of objects to be prioritized in migration.

6. The information processing apparatus according to claim 4,
wherein the setting part sets as the range of objects at least one of a number of upper levels to be migrated in a folder hierarchy and a number of lower levels to be migrated in the folder hierarchy.

7. The information processing apparatus according to claim 5,
wherein the setting part sets as the range of objects at least one of a number of upper levels to be migrated in a folder hierarchy and a number of lower levels to be migrated in the folder hierarchy.

8. The information processing apparatus according to claim 1, further comprising:
a condition setting part that sets a condition to be satisfied by an operation that is determined to be valid as the operation.

9. The information processing apparatus according to claim 2, further comprising:
a condition setting part that sets a condition to be satisfied by an operation that is determined to be valid as the operation.

10. The information processing apparatus according to claim 3, further comprising:
a condition setting part that sets a condition to be satisfied by an operation that is determined to be valid as the operation.

11. The information processing apparatus according to claim 4, further comprising:
a condition setting part that sets a condition to be satisfied by an operation that is determined to be valid as the operation.

12. The information processing apparatus according to claim 5, further comprising:
a condition setting part that sets a condition to be satisfied by an operation that is determined to be valid as the operation.

13. The information processing apparatus according to claim 6, further comprising:
a condition setting part that sets a condition to be satisfied by an operation that is determined to be valid as the operation.

14. The information processing apparatus according to claim 7, further comprising:
a condition setting part that sets a condition to be satisfied by an operation that is determined to be valid as the operation.

15. The information processing apparatus according to claim 8,
wherein the condition setting part sets as the condition to be satisfied detection of at least one of a multiple-file download operation, a single-file download operation, and an attribute reference operation.

16. The information processing apparatus according to claim 1, further comprising:
an acquiring part that acquires a file structure at the migration source and identification information to identify the one or more files at the migration source; and
a copying part that copies the file structure and the identification information to the migration destination before migrating content data of the one or more files at the migration source in the sequence, the file structure and the identification information being acquired by the acquiring part.

17. The information processing apparatus according to claim 16, further comprising:
a data acquiring part that acquires the content data of the one or more files at the migration source in the sequence; and
a data copying part that copies in the sequence the content data at the migration source to the file structure, the content data being acquired by the data acquiring part, the file structure being copied to the migration destination by the copying part.

18. The information processing apparatus according to claim 1, further comprising:
a migration-destination manager that serves as the migration destination and that manages a plurality of files.

19. An information processing system comprising:
an information processing apparatus including
a migration part that migrates content data of one or more files at a migration source to a migration destination in a predetermined sequence after migrating identification information to identify the one or more files at the migration source, and
a change part that changes the predetermined sequence so as to prioritize an object in migration if the object satisfies a predetermined condition and has been subjected to an operation to use a folder, a file, or another file relating to the file, the operation being performed at the migration destination while the content data is being migrated by the migration part; and
a migration-source manager that serves as the migration source and that manages a plurality of migration target files in a predetermined file structure together with identification information to identify the plurality of migration target files.

20. A non-transitory computer readable medium storing a program causing a computer to execute a process for information processing, the process comprising:
migrating content data of one or more files at a migration source to a migration destination in a predetermined sequence after migrating identification information to identify the one or more files at the migration source; and
changing the predetermined sequence so as to prioritize an object in migration if the object satisfies a predetermined condition and has been subjected to an operation to use a folder, a file, or another file relating to the file, the operation being performed at the migration destination while the content data is being migrated.
